(19) United States
(12) Patent Application Publication
(10) Pub. No.: US 2009/0033573 A1
(43) Pub. Date: Feb. 5, 2009

(54) Antistatic Coating For Surfaces Made Of Metal Materials And Dielectric Materials Or Of Dielectric Materials Only In Particular Antenna Surfaces And Method Of Application Thereof

(75) Inventors: Pasquale Capece, Roma (IT); Marco Manuel Ivagnes, Roma (IT)

Correspondence Address: LADAS & PARRY, 5670 WILSHIRE BOULEVARD, SUITE 2100, LOS ANGELES, CA, 90036-5679, US

(73) Assignee: FINMECCANICA S.P.A., Roma (IT)

(21) Appl. No.: 11/993,958

(22) PCT Filed: Jun. 28, 2006
(86) PCT No.: PCT/IT2006/000501

§ 371 Date: May 20, 2008

(30) Foreign Application Priority Data
Jun. 28, 2005 (IT) RM2005A000336

(51) Int. Cl. H01Q 1/32; C22C 28/00; C09K 3/16; H01Q 13/00

(52) U.S. Cl. 343/713; 420/556; 29/600

(57) ABSTRACT

Thin film coating for transferring antistatic characteristics to the surface on which it is placed, in particular antenna surfaces, in order to prevent electrical charge accumulations on it and discharge phenomenon.

Artificial satellites operate in an environment that can be described by the definition of four environmental features: neutral atmosphere (that typical of the Earth, optionally residual at the heights the satellite moves), plasma (made of multiple components typical of the satellite, such as nozzles and motors, or coming from the motion thereof, such as discharges and ionisation), corpuscular environment (consisting of micro meteorites, orbital debris and all the particles detached from the satellite itself) and finally, radiative environment (resulting both from electromagnetic waves and from flows of charged particles, mainly originated by the sun activity).

As regards plasmas, these represent a current flow towards the satellite surfaces, and towards the exposed parts of the power subsystems onboard thereof. Intrinsic unbalances in this current flow arise from the accumulation of charges on the surfaces exposed to the plasma. The charge may also be caused by photoelectrical effects, which make the surfaces emit low energy electrons when these are illuminated by the sun. For large sized satellites, in low orbits, currents may also be induced by the motion of the same through the geo-magnetic field. Lastly, the current flow may be modified by electrical fields optionally generated by high voltage power systems exposed onboard of the same satellite. The effects of the current flow along a satellite can be very strong, since they originate a differential accumulation of electrical charge on the exposed surfaces. These charges produce potential gradients between the electrically insulated surfaces of the satellite, those grounded and the spatial plasma.

For a geo-stationary satellite, the risk of destructive arc discharge is even higher, because even though the plasma is more rarefied than that found in low orbit, it is more energetic and can increase the potential gradient between the insulated surfaces and the surrounding space.

As regards the particles (ion and electron flows) that affect the satellite, they are equally responsible for the differential electrostatic charging of dielectric surfaces and materials. In particular, high energy particles, so-called fast, with energies of over hundreds of KeV, cross any external shields placed to protect the satellite surfaces and cause the charging of surfaces also internal to the satellite.

These electrostatic potential gradients can originate destructive arc or alternatively, micro-arc discharges that generate electromagnetic noise, therefore radiofrequency jamming and could even erode the surfaces. The arc discharge can therefore be regarded as one of the possible causes of abnormal behaviours of the satellites, up to their loss.

Also in the non-spatial field there are problems of differential charging of surfaces, caused by phenomena other than those described above, such as the presence of high local electrical fields, but in any case capable of causing interferences up to the triggering of arc discharge, if not suitably protected. Also in these cases, the application of the germanium coating can substantially reduce the differential charging.

### DESCRIPTION OF THE INVENTION

The proposal described in synthesis relates to the application of a thin film coating adapted for transferring antistatic characteristics to the surface on which it is placed. Such properties allows preventing electrical charge accumulations on an insulating surface from reaching such a level as to exceed a threshold level (called dielectric rigidity, typical of every insulating material) wherein a sudden and sometimes destructive discharge phenomenon in the material body itself triggers, which is crossed by an electrical current with negative results. The coating proposed, mostly consisting of a thin film of pure germanium and partly or totally stoichiometric oxides thereof, reduces this phenomenon up to annul it, imparting a light electrical conductivity to the surface it is deposited on, without altering or interfering with the operation of the antenna on which it is deposited. This property is especially important since between the surfaces of any satellite into orbit, subject to the charge accumulation problem, those of an active antenna are especially concerned by this phenomenon, which mainly concerns the outer rather than the inner surfaces, and they are also the most damaged by the same, since: 1) if the conditions are such as to cause an arc discharge with a high potential between outer surface of the antenna and surrounding spatial plasma, this can bring to a progressive erosion of the material forming the outer layer of the antenna itself during its operating life. This erosion could impair the structural integrity of the antenna or that of any metal elements arranged along the outer surface thereof, which considerably affect the performance thereof. 2) As an alternative, the uninterrupted presence of the micro-discharge phenomenon and of the electromagnetic waves that this phenomenon can generate, located in the emission surface of a radio signal with known frequency, width and gain, and intended for performing the primary satellite mission, could cause a degradation of the emitted signal and thus of the overall electrical performance of the antenna.

Unlike the metal materials, wherein the phenomenon of electrical conductivity is made possible by the presence of electrons that can freely move in the outer orbital layers of the component atoms, the electric conductivity in semiconductors is related to the presence of dislocations in the outer atomic structure, that allow a reduced mobility of the electrically charged particles, with conductivity values substantially lower than those found in the metal materials. This characteristic found in germanium also allows use thereof in non-spatial fields. Therefore it is an object of the invention an antistatic coating for surfaces made of dielectric and/or metal materials, essentially comprising a thin film of germanium or derivatives thereof. In a particular embodiment the surfaces made of dielectric and/or metal materials are surfaces of devices emitting electromagnetic waves, preferably satellite antennas.

In a particular embodiment the antistatic coating has a thickness as to exhibit an electrical resistivity per unit surface essentially from 10⁶ to 10⁹ Ω/ĺ.

It is another object of the instant invention a method for applying the antistatic coating for surfaces made of dielectric and/or metal materials wherein said thin film of germanium or derivatives thereof is deposited onto said surfaces by vacuum cathodic spray deposition. Preferably the draining system of the electrical charges is applied in at least one point of said surfaces, more preferably the draining system of the electrical charges consists of a metal wire or strap.

It is another object of the instant invention a satellite antenna having its radiant panel coated with the antistatic coating according to the invention.

### DETAILED DESCRIPTION OF THE INVENTION

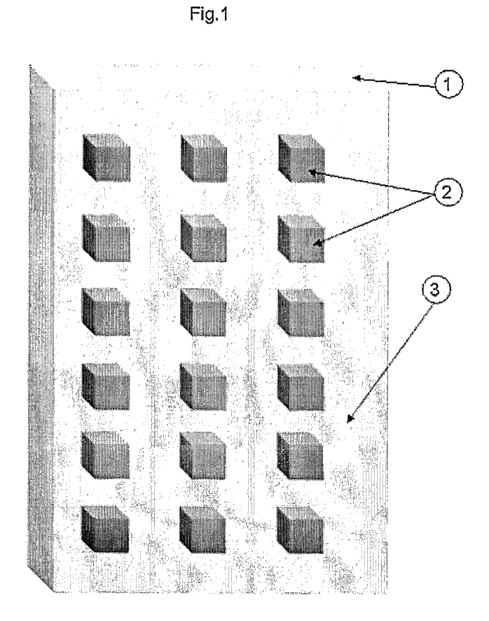

FIG. 1 represents a prospect high view of a radiant panel coated with the material of the invention;

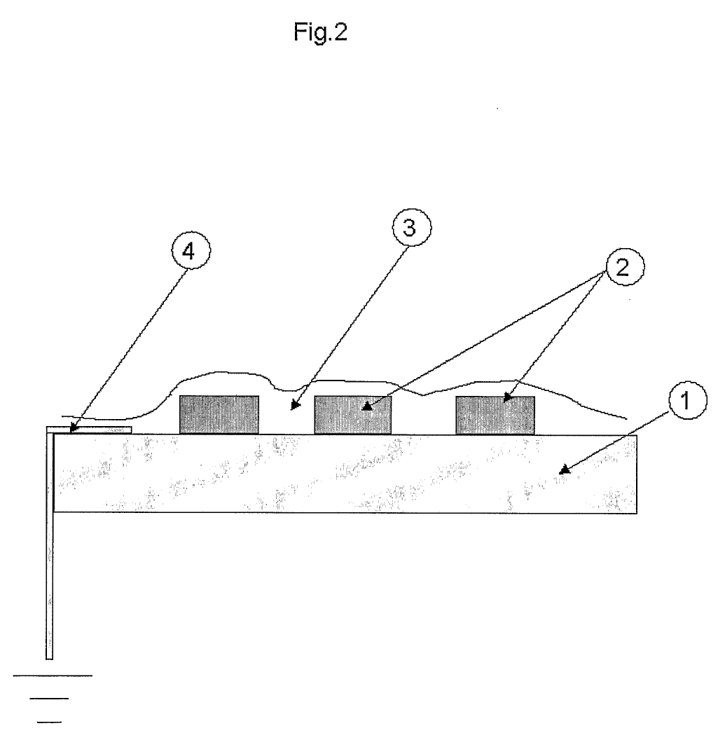

FIG. 2 represents a lateral view of a radiant panel coated with the material of the invention.

### 1—INTRODUCTION

The exposed surfaces on a satellite in any orbit, geo-stationary or else, travel enveloped in plasma and are continuously hit by a flow of particles and electromagnetic waves. Energy, charge and nature of these particles are a function of different parameters, among the most important we may mention height, position, and type of orbit, the presence or not of sun and last but not least important, the sun activity in the period examined. All of these parameters together contribute to the definition of an energy profile that affects any exposed point of the satellite. When the hit surface consists of dielectric material, this energy has no possibility of being sent towards a collecting well, where it may be concentrated and optionally transformed, but it remains for indefinite time in the incidence point. Over time, other collision events are concentrated in the same point and this phenomenon brings to an increase of the local charge value reached by the hit material. When this value exceeds that of threshold, called dielectric rigidity, typical of every insulating material, a discharge phenomenon triggers, which could have destructive effects and interfere with the antenna in the operation thereof.

### 2—FINALITY

The application of the thin germanium film on all the antenna surface, both on a metal material and optionally on the dielectric material present on the exposed surface, makes such surface unipotential and prevents local accumulation of charges, as this film is partly conductive. In fact, germanium is a material that can be defined as a semiconductor, since the structure thereof is not provided with a free valence band, typical of the metals and wherein the free electrons can slide causing the electrical conductivity phenomenon, but instead full of holes and dislocations wherein the charges move with reduced mobility and running into a certain resistance.

The germanium coating application on the surfaces of an antenna fully falls within the construction process of the antenna itself and can be regarded to all effects as a functional coating, meaning that its presence alters the natural behaviour of the material, which would otherwise be that of charging and discharging in repeated cycles with destructive end results.

### 3—PROCESS

The coating must be applied in thin thicknesses, which have the mentioned characteristic and do not easily detach from the substrate they are applied on. Germanium can be found on the standard market as a powder and other sintered forms with which it is possible to manufacture a target to use with any one of the chemical thin film vacuum deposition systems available. Even though the application is also allowed with evaporation systems, the coatings that can be obtained with this deposition system are not very adhering and coherent, and therefore they ensure coating durability not in line with the intended uses, which also envisage certain manual handling. Better results are obtained with the deposition system called sputtering, or vacuum cathode spraying. In one of the possible modes, the germanium to be deposited is first formed in a thin plate, placed in a pressurised environment at reduced pressure of inert gas, for example argon. The chamber where deposition is carried out is connected to a discharge system operating uninterruptedly, provided with pumps for primary (low vacuum up to 10⁻² torr) and secondary suction (high vacuum up to 10⁻⁶ torr). The process generally takes place in optimum conditions uninterruptedly at the pressure of about 10⁻³ torr. The potential difference between chamber and target, brought to a negative voltage of a few hundreds volts compared to the chamber and the low pressure environment favour the triggering of a plasma discharge. This discharge, that expresses in a luminescence diffused in the entire chamber, brings to the formation of a plasma mostly consisting of positive gas ions. The presence of a radiofrequency supply, for example at 13.5 MHz, connected to the target, favours the plasma confining in the proximity of the target, a phenomenon that increases the frequency of the collisions of the positive ions on the target itself and determines the removal of material therefrom. In this way, germanium is extracted from the target. The extracted atoms condensate on the substratum to be coated, located opposite the germanium target.

### 4—PRODUCT

The coating formed by the process described in the previous paragraph has a metal grey appearance and the more polished and smooth the surface to be coated, the greater the mirror appearance. The extension of the surface to be coated has no defined limits, provided it consists of modular elements, each having such dimension and shape as to be introduced in a vacuum deposition chamber by direct introduction, opening all the chamber or through a valve or airlock chamber, which allows introducing the parts to be treated into the chamber without aerating the latter to the atmosphere.

To assess the electric conductivity or better, the electrical resistance of a surface, the use of parameter Ω/ĺ (ohm/square) is established, which describes the resistance in ohm, measurable on the sides of a square of any dimension. For thin metal coatings, therefore with a high electrical conductivity, this parameter has a value of 10⁻³-10⁰ Ω/ĺ, for thin semiconductor coatings it has a value of 10¹-10¹⁰ Ω/ĺ, for insulating or dielectric materials it has a value of 10¹²-10¹⁴ Ω/ĺ.

The coating deposited in the conditions of the above item 3 of this description must have a surface electrical resistivity comprised in the range 10⁶-10⁹ Ω/ĺ to operate well on a device emitting electromagnetic waves. Values below 10⁶ Ω/ĺ could denote a too conductive coating, which could cause interferences with the regular operation of the device emitting electromagnetic waves, or a too large thickness, which could denote poor duration of the same coating over time. Values below 10⁶ Ω/ĺ could in any case be used when the application surface is not part of a device emitting electromagnetic waves. Values above 10⁹ Ω/ĺ denote a too resistive coating that is not able to drain the electrostatic charges away.

To complete the product, before the product is deposited on the coating application surface, an electrical ground connection consisting of a wire or a strap of copper or other high conductivity metal should be made to adhere thereto in a steady manner by gluing or welding, which may be used to place in electrical connection the surface, which should then be made antistatic and thus of low electrical conductivity, with the rest of the equipment. This connection may be located at the sides of the base element to be coated in any number of points.

### DETAILED DESCRIPTION WITH REFERENCE TO THE DRAWINGS

In one of the possible embodiments, the coating is applied to the outer surface of a radiant panel, the latter consisting of a multilayer structure of printed circuits divided by continuous dielectric spacers; the printed circuits are obtained starting from a fiberglass or in any case dielectric substrate and epoxy or in any case organic resin, with electrical circuits with discrete or continuous elements made of copper or other high electrical conductivity metal, previously photo-engraved starting from a layer of continuous metal made to adhere to the substrate in different manners. In FIG. 1, the fiberglass or dielectric and epoxy or organic resin substrate is represented with the number 1, the discrete metal elements with number 2, whereas number 3 denotes the thin coating, distributed evenly on the entire surface.

Before the coating is applied, it is advisable to thoroughly clean the application surface, whatever it is, to favour the adhesion of the germanium coating. The cleaning may be carried out with different methods, but the two-step one is preferred, the first one based on the use of light organic solvents such as isopropyl alcohol, concentrated ethyl or acetone, applied by soaked flocks, manually rubbed on the application surface, in order to remove any grease and organic impurities; if the amount of organic residues is such as to require stronger actions, the use of brushes with hard synthetic bristles of the dental type is allowed as well, if it is certain that the substrate will not be damaged.

The second substrate cleaning step on the other hand, should be carried out in the same chamber where the antistatic coating is deposited, by a cleaning process using inert gas plasma. As for the deposition operation, the substrate to be cleaned is brought to low pressure, in the same environment evacuated continuously and fed with a reduced flow of inert gas, such as argon. In this step, a moving shield excludes the view of the substrate to be cleaned to the target. The plasma is created by a reduced electrical voltage between an element acting as cathode and the body of the same deposition machine. In these conditions, the gas ions hit the substrate to be cleaned, removing the residual impurities and activating or better, “electrified” the coating application surface. In this way, the adhesion of the coating subsequently applied is considerably increased.

In one of the possible embodiments, the layer whereon the germanium coating is applied therefore consists of a printed circuit wherein the exposed surface consists by about the half of the total extension by epoxy resin reinforced by fiberglass and by the remaining half by small metal elements, of any shape, for example square. FIG. 2 shows a substrate of the type just described, wherein the fiberglass or in any case dielectric and epoxy or in any case organic substrate is represented with the number 1, the discrete metal elements with number 2, whereas number 3 denotes the thin coating, evenly distributed on the entire surface, and number 4 denotes a connection consisting of a wire or a strap made of copper or other conductive metal, located in any point, preferably along the surface edge, mechanically connected thereto by welding or gluing or riveting, coated by the same coating present on the entire device surface, which in this way can drain the charges towards a suitable electrical ground located also at a distance from the surface.

1. An antistatic coating for surfaces made of dielectric and/or metal materials, essentially comprising a thin film of germanium or derivatives thereof.

2. An antistatic coating according to claim 1, wherein surfaces made of dielectric and/or metal materials are surfaces of devices emitting electromagnetic waves.

3. An antistatic coating according to claim 2, wherein the devices emitting electromagnetic waves are satellite antennas.

4. An antistatic coating according to claim 1, having such thickness as to exhibit an electrical resistivity per unit surface essentially from 10⁶ to 10⁹ Ω/ĺ.

5. A method for applying the antistatic coating for surfaces made of dielectric and/or metal materials according to claim 1, wherein said thin film of germanium or derivatives thereof is deposited onto said surfaces by vacuum cathodic spray deposition.

6. A method for applying the antistatic coating for surfaces made of dielectric and/or metal materials according to claim 5, wherein a draining system of the electrical charges is applied in at least one point of said surfaces.

7. A method for applying the antistatic coating for surfaces made of dielectric and/or metal materials according to claim 6, wherein the draining system of the electrical charges consists of a metal wire or strap.

8. A satellite antenna having its radiant panel coated with the antistatic coating according to claim 1.
